(19) United States
(12) Patent Application Publication
(10) Pub. No.: US 2024/0358017 A1
(43) Pub. Date: Oct. 31, 2024

(54) SPIDER WEB ERADICATION AND SPIDER REPELLANT COMPOUND AND METHODS OF USE

(71) Applicant: DALRAY, LLC., Fulshear, TX (US)

(72) Inventors: Dalva Alexander, Fulshear, TX (US); Martin James La Grange, Auckland (NZ)

(21) Appl. No.: 18/645,866

(22) Filed: Apr. 25, 2024

Related U.S. Application Data
(60) Provisional application No. 63/498,174, filed on Apr. 25, 2023.

(51) Int. Cl. A01N 37/36; A01N 25/02; A01N 65/22; A01N 65/28; A01N 65/36; A01P 17/00

(52) U.S. Cl. CPC A01N 37/36; A01N 25/02; A01N 65/22; A01N 65/28; A01N 65/36; A01P 17/00

(57) ABSTRACT

A biodegradable, non-toxic, formulation for degrading webs by web-producing spiders and other species and, in preferred embodiments, repelling such species.

### STATEMENT OR PRIORITY

This application claims priority under 35 U.S.C. § 119 (c) to U.S. Provisional Patent Application No. 63/498, 174 filed on Apr. 25, 2023, which is hereby incorporated by reference in its entirety.

### FIELD OF THE INVENTION

The present invention relates to the chemical degradation of existing substrates.

### BACKGROUND OF THE INVENTION

Spider webs are a well-known nuisance, and even hazard in some contexts. Not only spiders, but other species product “silk” and may pose similar problems. These include Silkworms a wide range of moth species, raspy crickets, honeybee and bumblebee larvae, bulldog ants, weaver ants, caddisfly larvae, webspinners, hornets, silverfish, mayflies, thrips, leafhoppers, certain beetles, lacewings, fleas, certain flies, midges, caterpillars of many butterfly species, and parasitic wasps such as braconids.

Anyone who has inadvertently encountered a web at face level while walking about will appreciate at least that unpleasant aspect of webs in any environment shared by humans. Slips and fall type, and other accidents are said to have come from peoples' instinctive reactions to such encounters, and even worse from bites suffered by those who encounter certain occupied webs.

Direct human encounters are far from the only problems of widely ranging severity that arise from web propagation by the various web-producing species. Among the most benign, but still problematic, are the aesthetic issues of a web-infested structure.

Any home, venue or place of business with significant web contamination will, beyond reasonable debate, appear poorly maintained and unsanitary. Further, many will fear to enter or remain near such a structure for fear of direct encounters with spiders and the like, whether from a fact-based fear of bites from poisonous species, or from a the very widely held phobia of any insect or spider-like encounter.

The problems of web infestation quickly escalate in severity from the aesthetics. Webs are often constructed in “protected” areas. These include the interiors of conduits and the interior spaces of any number of mechanical devices or other human-made structures. Among near countless examples of problems from web infestation of devices and apparatuses are: obstruction of pump intake orifices or conduits, obstruction of air filters, obstruction of smoke and other hazardous substance detector orifices, and (among the most potentially deadly) the obstruction of airspeed detection devices (known as “pitot tubes” on aircraft.

Clearly, one can remove most webs by manual labor, such as by sweeping and scrubbing. In some contexts, burning of webs with such as propane burners is a method of choice, albeit a potentially dangerous one. Pressure washers can be used as a general proposition, but in many contexts (such as the earlier aircraft-related issues), such is not a realistic or safe option. There are, of course, caustic or acidic compounds that one might imagine using to dissolve webs, but such are likely to damage many surfaces and objects that would be sought to be de-infested of webs, and furthermore would run afoul of various safety and environmental laws and regulations.

The above possible avenues for addressing web infestation share an additional limitation to those that are already readily apparent—they would only, at best, remove existing webs, and not inhibit return by their builders.

As will be described and explained below, the present investors employ surfactants and emulsifiers as part of their effective and otherwise beneficial formulations. Surfactants spread the acids over the web to make this process efficient and effective. They also adhere to the lipid (fat) sheath layers of the web to allow the active ingredients to perform their function. However, not just any surfactant or emulsifier may be ideally used. Under applicable environmental regulations, only certain surfactants may be used as “green-approved” ones, and, pursuant to “EPA's”—the United States Environmental Protection Agency's “List 25B” of approved biopesticide ingredients, emulsification agents used to fully emulsify essential oils are not permitted. So, extensive research was required to both determine effective and safe constituents to the here-disclosed formulations, but also to produce regulatory compliant ones.

### SUMMARY OF THE INVENTION

In view of the foregoing, it would be advantageous to provide new formulae for compounds, and associated methods of use, for easily, safely, legally, and effectively eradicates webs produced by web-producing species, such as spiders.

It would be further advantageous to provide such compounds that inhibit, directly or indirectly, the re-appearance of webs so eradicated.

It would be further advantageous to provide such compounds that are at least significantly of constituents that are both of natural (non-compounded or formulated) and are bio-degradable.

It would be further advantageous to provide some such compounds that are transportable by common carrier without the need for hazardous cargo designations or handling.

The present inventors here disclose novel and unobvious formulations and associated methods for use thereof for web-eradicating compounds that are beneficial to any users who have a need for addressing problems associated with web infestation of structures, devices or apparatuses.

### DETAILED DESCRIPTION OF THE PREFERRED EMBODIMENT

The present inventors have devised several variations of formulations for web eradication, each with a different balance of characteristics, benefits, and adoption considerations.

The first exemplary formulation (“Formula 1”) includes the chemically active organic acids (Citric Acid and Acetic Acid in Vinegar) with two surfactants (Cocamiopropyl Betaine and Decyl Glucoside). For repellant purposes, essential oils (e.g., Tea Tree, Peppermint, Eucalyptus) emulsified in Polysorbate 20 are included.

The second formulation (“Formula 2”) is an alternative that, while still quite effective, is modified vis a vis Formula 1 to utilize “EPA Green” ingredients. Cocamipropyl Betaine of Formula 1 is replaced with Lauramidopropyl Betaine, with effectively equivalent performance as Cocamipropyl Betaine serves in Formula 1. In this Formula 2, Polysorbate 20 is replaced by Decyl Glucoside. Essential oils remain present as repellents.

A third formulation (“Formula 3”) is somewhat less effective than the prior Formulae 1 and 2, but is modified as to utilize EPA 25B Biopesticide permitted ingredients. The single permitted surfactant, Sodium Lauryl Sulphate (a soap) is used to spread the active ingredient (Citric Acid in this case) over the surface of the target substrate (spider web) for persistence during action. Alternatives for this surfactant (also approved by regulatory agencies) include Lauramidopropyl, Betaine, and Decyl Glucoside.

A fourth formulation (“Formula 4”) is identical to Formula 3 but makes use of commercial detergent-stabilized Papain enzyme. Papain enzyme is not a permitted ingredient under EPA 25B regulated ingredients. However, this enzyme, in combination with the organic acids mentioned before, have a complimentary action on web substrates for (based on research by the present inventors to-date) the greatest efficacy of the presently presented formulations.

Acetic Acid (Vinegar 5-8%) is ideally included as a preservative in the above formulations and, in such contexts, would be considered an inert ingredient. Water is finally utilized as the inert solvent for these combinations.

The relative volumetric presence of the above constituents is, in the most efficacious formulations in degrading webs as tested to-date, is respectively as follows: Sodium Lauryl Sulphate—1.00%; Citric Acid (Anhydrous)—0.750%; Acetic Acid—1.20%; and Water to 100%.

As to the organic acid components of the above formulations, the chemical reaction for web degradation is exemplified by the following:

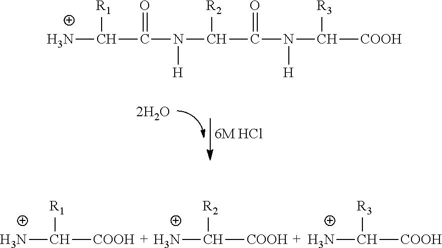

Of course, alternatives to some of the constituents listed above, and that would serve like corresponding functions (as indicated in the following) are acceptable: List 25B contains a large number of optional ingredients which could be incorporated into the product to achieve certain, slight performance adjustments. These include: Diglyceryl monooleate (DGMO)—emulsifier/spreading agent, 0.2%-0.3% v/v; Diglyceryl monostearate (DGMS)—emulsifier/spreading agent, 0.2%-0.3% v/v; Isopropyl alcohol—spreading agent; desiccant, 0.5% v/v [optional]; and Salt—addition will allow mix-emulsion of DGMO & DGMS, 0.2-0.3% v/v.

While quite beneficial if the only function of the present formulations was to dissolve webs as described, the preferred embodiments include essential oils to (as alluded to above) repel the web-generating species that produce the webs in the first place, and thereby reduce the recurrence of webs.

The following essential oils (or combinations of oils) were found to be ideal as an adjunct to the above web eradication formulation: (1) mint and eucalyptus (1:1); (2) mint and lemon (1:1); (3) mint and orange (1:1); (4) mint and tea tree (1:1); (5) Eucalyptus and Lemon (1:1); (6) Eucalyptus and Orange (1:1); (7) Eucalyptus and Tea Tree (1:1); (8) Orange and Lemon (1:1); (9) Eucalyptus; (10) mint; (11) Tea Tree; (12) Orange; and (13) Lemon.

The oils are, for the preferred embodiment, emulsified using polysorbate 20 or Decyl Glucoside on a 1:1 ratio vis a vis the essential oil or oil combination.

Not only do the above essential oils (and other functional equivalents as known to persons of skill in the art are not listed) serve as highly effective repellants to web-generating species (and thus an agent in preventing the return of webs once removed), they also serve as a preservative for the completed compositions. Testing has revealed at least a 6 to 9 month shelf life of the subject product.

It is important to note that the surfactants described above act as a buffer to the organic acids and thereby serve to mitigate any reaction with surfaces on which the subject formulations are applied.

As a volumetric constituent, the above oils or oil combinations (with emulsifier) were added (replacing a like volume percentage of water) at 0.1 through 0.5% by volume of the entire formulation.

Preferred constituencies and preparation methods for each of the four formulations follow (note that present inventors' research has found that substantially achieving the indicated pH of the end compositions [within a range to be discussed later] is roughly proportionate to the efficacy thereof):

Formula 1 Preferred Embodiment Constituents:

| Ingredient | % Composition | |
|---|---|---|
| Cocamidopropyl Betaine | 2% | v/v |
| Decyl Glucoside | 3% | v/v |
| Polysorbate 20 | 0.5% | v/v |
| Essential Oil | 0.5% | v/v |
| Citric Acid | 0.375% | m/v |
| Acetic Acid (Vinegar | 0.9% | v/v |
| 5% Acetic Acid) | | |

Exemplary essential oils and preferred relative proportions for repellant purposes (for all present formulations): Mint & Eucalyptus—1:1; Mint & Lemon—1:1; Mint & Orange—1:1; Mint & Tea Tree—1:1; Eucalyptus & Lemon—1:1; Eucalyptus & Orange—1:1; Eucalyptus & Tea Tree—1:1; Orange & Lemon—1:1; Eucalyptus; Mint; Tea Tree; Orange; and/or Lemon.

### Formula 1 Mixture Process

### Step 1: Surfactants

a. Fill mixing container with water, to a ½ of total batch size;
b. Add agitation mixer, and set water into motion; and
c. Add surfactants—Decyl Glucoside, Cocamidopropyl betaine

### Step 2: Emulsion

a. In a separate empty container, add the required amount of essential oils for the formulation;
b. Emulsify in the equivalent amount of Polysorbate 20;
c. The emulsified mixture has the appearance of a milky liquid;
d. Use water to wash the emulsion out of the mixing container, into the batch mixing container; and
e. Allow the mixture to mix until clear

### Step 3: Organic Acids

a. Add the organic acids to the batch mixture; and
b. Allow the batch to mix until fully dissolved

### Step 4: Completion of Batch

a. Complete batch with water to desired volume; and
b. Allow mixture to stir until clear.

### Formula 1 QC Criteria

a. Color: Clear Liquid;
b. Viscosity: 1 cp at 25° C. (equivalent of water); and
c. pH: 3.0 at 25° C.

Formula 2 Preferred Embodiment Constituents:

| Ingredient | % Composition | |
|---|---|---|
| Lauramidopropyl Betaine | 2% | v/v |
| Decyl Glucoside (Surfactant | 2.0% | v/v |
| Fraction) | | |
| Decyl Glucoside (Emulsion | 1.0% | v/v |
| Fraction) | | |
| Essential Oil | 0.5% | v/v |
| Citric Acid | 0.375% | m/v |
| Acetic Acid (Vinegar | 0.9% | v/v |
| 5% Acetic Acid) | | |

### Formula 2 Mixture Process

### Step 1: Surfactants

a. Fill mixing container with water, to a ½ of total batch size;
b. Add agitation mixer, and set water into motion; and
c. Add surfactants—Decyl Glucoside (Surfactant fraction), Lauramidopropyl betaine.

### Step 2: Emulsion

a. In a separate empty container, add the required amount of essential oils for the formulation;
b. Emulsify in twice the equivalent amount of Decyl Glucoside (Emulsion Fraction);
c. The emulsified mixture has the appearance of a milky liquid;
d. Use water to wash the emulsion out of the mixing container, into the batch mixing container; and
e. Allow the mixture to mix until clear.

### Step 3: Organic Acids

a. Add the organic acids to the batch mixture; and
b. Allow the batch to mix until fully dissolved.

### Step 4: Completion of Batch

a. Complete batch with water to desired volume; and
b. Allow mixture to stir until clear.

### Formula 2 QC Criteria

a. Color: Clear Liquid
b. Viscosity: 1 cp at 25° C. (equivalent of water); and
c. pH: 3.0 at 25° C.

Formula 3 Preferred Embodiment Constituents:

| Ingredient | % Composition | |
|---|---|---|
| Sodium Lauryl Sulphate | 1% | v/v |
| Citric Acid | 0.750% | m/v |
| Acetic Acid (Vinegar | 1.20% | v/v |
| 5% Acetic Acid) | | |

### Formula 3 Mixture Process

### Step 1: Surfactant

a. Fill mixing container with water, to a ½ of total batch size;
b. Add agitation mixer, and set water into motion; and
c. Add surfactant—Sodium Lauryl Sulphate.

### Step 2: Organic Acids

a. Add the organic acids to the batch mixture; and
b. Allow the batch to mix until fully dissolved.

### Step 3: Completion of Batch

a. Complete batch with water to desired volume; and
b. Allow mixture to stir until clear.

### Formula 3 QC Criteria

a. Color: Clear Liquid;
b. Viscosity: 1 cp at 25° C. (equivalent of water); and
c. pH: 3.0 at 25° C.

Formula 4 Preferred Embodiment Constituents:

| Ingredient | % Composition | |
|---|---|---|
| Sodium Lauryl Sulphate | 1% | v/v |
| Citric Acid | 0.750% | m/v |
| Acetic Acid (Vinegar | 1.20% | v/v |
| 5% Acetic Acid) | | |
| Papain Enzyme | 0.5% | v/v |

### Formula 4 Mixture Process

### Step 1: Surfactant

a. Fill mixing container with water, to a ½ of total batch size.
b. Add agitation mixer, and set water into motion
c. Add surfactant—Sodium Lauryl Sulphate

### Step 2: Organic Acids

a. Add the organic acids to the batch mixture; and
b. Allow the batch to mix until fully dissolved

### Step 3: Enzyme

a. Add enzyme powder to mixture; and
b. Allow to stir until clear.

### Step 4: Completion of Batch

a. Complete batch with water to desired volume; and
b. Allow mixture to stir until clear.

### Formula 4 QC Criteria

a. Color: Clear Liquid
b. Viscosity: 1 cp at 25° C. (equivalent of water)
c. pH: 3.0 at 25° C.

As mentioned, the pH of compositions within the present invention(s) is an important feature of efficacy. Research to-date has revealed that a pH range of approximately 2.0-6.0 is efficacious, with efficacy increasing with increasing acidity (lower pH).

pH of approximately within this range is that at which the fibrin and other proteins of a spider webs are disrupted by hydrolysis, and the spider web degrades. As compositions of the present invention(s) are fabricated, the constituencies should be adjusted, as needed, to achieve end products of such acidity.

At pH 7.0, the hydrolysis reaction is practically non-existent—the balance of H═ and OH— ions, acidic and alkaline in water solution respectively, are balanced as in neutral water. Spider webs are able by nature to not be affected.

pH level has been set in formulations principally by Citric Acid, though also with contribution of Acetic Acid, as found in Vinegar. Both are approved in EPA 25B regulations as active and inert ingredients respectively.

pH below 2.0 products would require safety warnings and special handling. Also, the impact on, for example, painted or metallic surfaces are likely to be increasingly deleterious, particularly as the lower end of the recommended pH range is reached, and this should be considered by formulators and users alike.

Use of the formulations of the present invention is straight forward. In the simplest form, the solutions can be applied by a simple hand-pump garden sprayer. More pressurized, long-reach delivery may be achieved through various motorized pump systems as are readily available in the marketplace. After observed degradation of the target webs, the resulting “clumps” of digested webs may be simply rinsed from any surface with water.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

We claim:

1. A formulation for chemically degrading webs by web-producing species comprising:
an organic acid;
a surfactant; and
a non-active host fluid.

2. The formulation of claim 1 wherein the organic acid is citric acid.

3. A formulation for chemically degrading webs by web-producing species comprising:
citric acid;
a surfactant; and
a non-active host fluid.

4. A formulation for chemically degrading spider webs and for repelling spiders:
citric acid;
an emulsifier;
a surfactant;
a non-active host fluid; and
a first essential oil.

5. The formulation of claim 4 further comprising a second essential oil.

6. The formulation of claim 1 wherein said constituents are mixed to reach a pH of between approximately pH2 and pH6.

7. The formulation of claim 2 wherein said constituents are mixed to reach a pH of between approximately pH2 and pH6.

8. The formulation of claim 3 wherein said constituents are mixed to reach a pH of between approximately pH2 and pH6.

9. The formulation of claim 4 wherein said constituents are mixed to reach a pH of between approximately pH2 and pH6.

10. A method for degrading webs by web-producing species comprising the steps of:
selecting a liquid compound comprising an organic acid; a surfactant; and a non-active host fluid; and
applying said compound to a web.

11. A method for degrading webs by web-producing species and for repelling such species after use comprising the steps of:
selecting a liquid compound comprising an organic acid; an emulsifier; a surfactant;
a non-active host fluid; and a first essential oil; and
applying said compound to a web.

12. The method of claim 10 wherein said organic acid is citric acid.

13. The method of claim 11 wherein said organic acid is citric acid.

14. The method of claim 10 wherein constituents of said liquid compound are mixed to reach a pH of between approximately pH2 and pH6.

15. The method of claim 11 wherein constituents of said liquid compound are mixed to reach a pH of between approximately pH2 and pH6.
